(19) United States
(12) Patent Application Publication
(10) Pub. No.: US 2004/0170241 A1
(43) Pub. Date: Sep. 2, 2004

(54) Frame synchronization method

(76) Inventors: Junji Kondou, Tagawa-Gun (JP); Yuji Igata, Chikushino (JP); Akio Kurobe, Tondabayashi (JP); Shigeo Yoshida, Takatsuki (JP); Norihiro Miyashita, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/780,766

(22) Filed: Feb. 19, 2004

(30) Foreign Application Priority Data
Feb. 20, 2003 (JP) 2003-042823

(51) Int. Cl. H04L 7/00

(52) U.S. Cl. 375/354

(57) ABSTRACT

Two or more synchronous words are arranged to a section as long as a noise cycle “t” regarding a frame. Or, one or more synchronous words are arranged such that a section not being influenced by the noises is long enough considering the noise cycle. When information that cyclical noises occur is given and/or the noise cycle can be measured, probability that the synchronous word is influenced by the noises is reduced so that reliability of frame synchronization establishment can be improved.

### BACKGROUND OF THE INVENTION

1. Field of the Invention

The present invention relates to a frame synchronization method for taking measures against cyclical noises. In this specification, “frame synchronization” means that a receiver finds out data from the received frame composed of a bit string.

2. Description of the Related Art

In order that a receiver can determine the position of necessary data from the received frame composed of the bit string, there is technique which a transmitter adds one or more synchronous words to a frame to be transmitted to the receiver so that the receiver can establish synchronization using the one or more synchronous words.

In this technique, the receiver carries out correlation calculation using one or more synchronous words that the receiver itself holds before the receiver receives the frame.

Even when noise induced in a transmission line has adverse influence on a part of the received frame, causing a bit error to occur, the receiver can determine the position of data and can take the data out, i.e., extract the data from the received frame.

Published Japanese Patent Application Laid-Open No. H03-72736 discloses countermeasures to a case where the influence of noise is strong. That is, when a plurality of synchronous words is provided in one frame and at least one synchronous word is detected, it is judged that frame synchronization has been established.

In this technique, when the number of the synchronous words provided in the frame increases, reliability of frame synchronization establishment becomes higher indeed.

However, in prior art, the frame is constituted regardless of the noise cycle in the transmission line.

Therefore, when cyclical noises occur in the transmission line, the reliability of frame synchronization establishment is reduced.

### OBJECTS AND SUMMARY OF THE INVENTION

An object of the present invention is to provide a frame synchronization method for reducing effects of cyclical noises to improve reliability of the frame synchronization.

A first aspect of present invention provides a frame synchronization method comprising determining a parameter of one or more synchronous words according to a cycle of the cyclical noises.

With this structure, when it has been known that cyclical noises occur, probability that the one or more synchronous words are influenced by the cyclical noises is reduced so that reliability of frame synchronization establishment can be improved.

A second aspect of the present invention provides a frame synchronization method as defined in the first aspect, wherein length of the synchronous word is almost equal to an integral multiple of a cycle of the cyclical noises by a natural number.

With this structure, when the length of the synchronous word is equal to the cycle of the cyclical noises, since the noises that influence the synchronous word are, at most, noises that exist in the cycle of the cyclical noises, the probability that the noises will influence the synchronous word is reduced.

A third aspect of the present invention provides a frame synchronization method as defined in the first aspect, wherein, a plurality of synchronous words are arranged on one frame such that the plurality of synchronous words are settled within a section equal to the cycle of the cyclical noises.

With this structure, the possibility that at least one synchronous word being not influenced of cyclical noises exists can increase.

A fourth aspect of the present invention provides a frame synchronization method as defined in the first aspect, wherein a plurality of synchronous words are arranged on one frame such that an arrangement interval of at least one pair of the plurality of synchronous words are different from that of the other pair of the plurality of synchronous words.

With this structure, the possibility that at least one of the plurality of synchronous words is not influenced by the cyclical noises can increase.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a communication system in embodiments 1 to 3 of the present invention;

FIG. 2 is a flow chart of a transmitter in the embodiments 1 to 3 of the present invention;

FIG. 3 is a flow chart of a receiver in the embodiments 1 to 3 of the present invention;

FIG. 4 is a block diagram of a frame in the embodiment 1 of the present invention;

FIG. 5 is a block diagram of a frame in the embodiment 2 of the present invention; and

FIG. 6 is a block diagram of a frame in the embodiment 3 of the present invention.

### DETAILED DESCRIPTION OF THE PREFERRED EMBODIMENTS

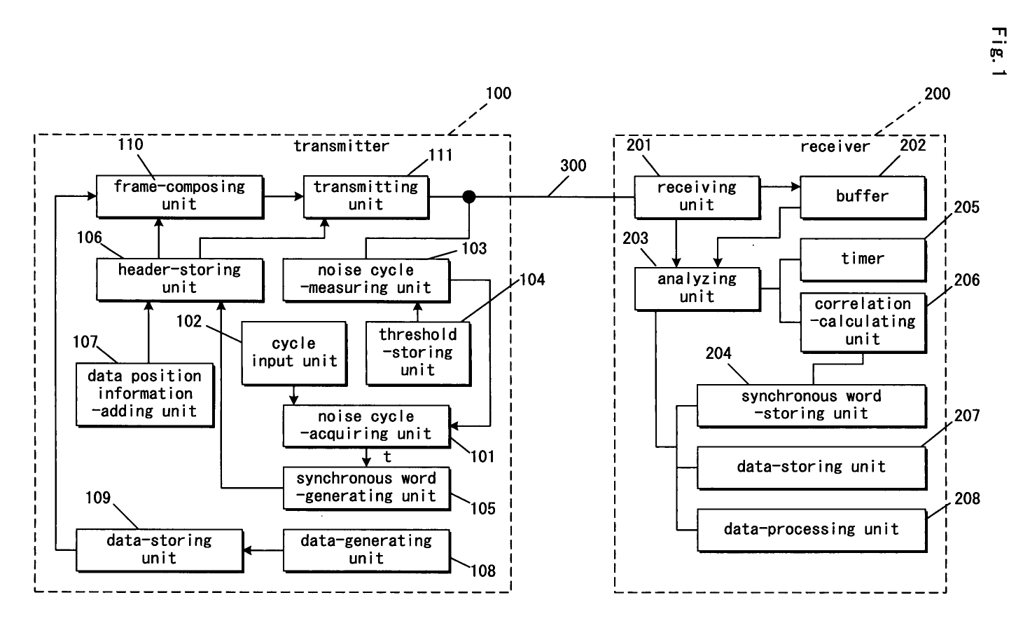

Hereinafter, referring to the drawings, embodiments of the present invention will now be explained. FIG. 1 is a block diagram of a communication system in embodiments 1 to 3 of the present invention.

In this communication system, a transmitter 100 and a receiver 200 connect via a transmission line 300, and the transmitter 100 transmits data to the receiver 200 using a frame synchronization method. Of course, both the transmitter 100 and the receiver 200 may be mounted on one apparatus, that is, a transmitter/receiver, and two-way communications may be carried out via the transmission line 300.

The transmitter 100 comprises the following elements. A noise cycle-acquiring unit 101 acquires a noise cycle “t” in the transmission line 300. When the noise cycle “t” is known, the noise cycle “t” may be inputted into the noise cycle-acquiring unit 101 from a cycle input unit 102, which is a keyboard, switches, or a communication port, and so on. Or, the noise cycle “t” may be inputted as a value measured by a noise cycle-measuring unit 103. Herein, the noise cycle-measuring unit 103 is connected to the transmission line 300 and measures a cycle of the cyclical noises, which occur on the transmission line 300 and have a noise level beyond a predetermined threshold of noise level. The predetermined threshold is stored on a threshold-storing unit 104.

A synchronous word-generating unit 105 inputs the noise cycle “t” from the noise cycle-acquiring unit 101, and generates one or more synchronous words based on the noise cycle “t”. Methods for generating one or more synchronous words will be explained in detail later, using some examples.

A header-storing unit 106 stores one or more synchronous words generated by the synchronous word-generating unit 105. A header that constitutes a frame may be composed from one or more synchronous words, and may include other information, for example, data position information, and so on.

A data position information-adding unit 107 decodes predetermined data position information into an error-detecting-code to add the error-detecting-code to information stored on the header-storing unit 106.

A data-generating unit 108 generates data and the generated data are stored in the data-storing unit 109. When a header is stored in the header-storing unit 106 and data are stored in the data-storing unit 109, a frame-composing unit 110 composes the header stored in the header-storing unit 106 and the data stored in the data-storing unit 109 to output the composed data as a frame.

The frame generated by the frame-composing unit 110, which is parallel data, is changed into serial data by a transmitting unit 111, and the serial data is transmitted to the receiver 200 via the transmission line 300.

In advance of the transmission of the frame, the transmitting unit 111 transmits the one or more synchronous words stored on the header-storing unit 106 to the receiver 200 via the transmission line 300.

The receiver 200 comprises the following elements. A receiving unit 201 acquires the serial data from the transmission line 300, and changes the serial data into parallel data.

When the receiving unit 201 receives one or more synchronous words, the receiving unit 201 outputs one or more synchronous words to an analyzing unit 203. The analyzing unit 203 stores the one or more synchronous words into a synchronous word-storing unit 204. When the receiving unit 201 receives a frame, the receiving unit 201 saves the frame into a buffer 202.

The analyzing unit 203 judges a success/failure of synchronous establishment according to procedures described below. In this judgment, a timer 205 is used for judgment of whether or not the time is up, and a correlation-calculating unit 206 performs correlation-calculation between the one or more synchronous words stored in the synchronous word-storing unit 204 and one or more synchronous words stored in the buffer 202 to output a correlation value thereof to the analyzing unit 203. This correlation calculation does not need to be special and may be a well-known calculation.

When the analyzing unit 203 judges that the synchronous establishment of a frame has succeeded, data contained in the frame is stored in the data-storing unit 207, which is processed by the data-processing unit 208 after that. The data, which is generated by the data-generating unit 108 and is processed by the data-processing unit 208, is arbitrary.

In FIG. 1, each of the buffer 202 and elements indicated using terms of “storing unit”, is composed of a specific region of a memory, and so on. Each of the other elements of FIG. 1 may be composed of special hardware circuits or a combination of a processor and software operating thereon.

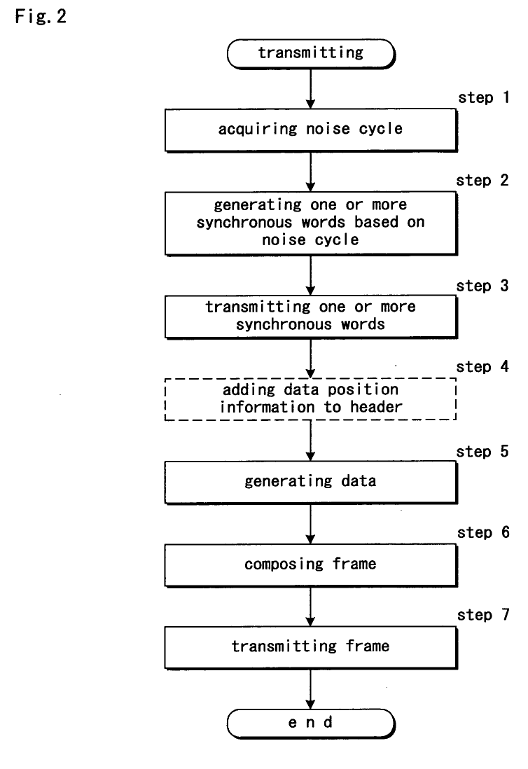

Next, referring to FIG. 2, an outline of operation of the receiver 200 will now be explained. First, at step 1, the noise cycle-acquiring unit 101 acquires a noise cycle “t” to outputs the noise cycle “t” to the synchronous word-generating unit 105. Herein, the noise cycle “t” may be either an input value from the cycle input unit 102 or a measured value by the noise cycle-measuring unit 103.

At step 2, the synchronous word-generating unit 105 generates one or more synchronous words based on the noise cycle “t” to store the one or more synchronous words into the header-storing unit 106.

At step 3, the transmitting unit 111 transmits the one or more synchronous words stored in the header-storing unit 106 to the receiver 200 via the transmission line 300.

At step 4, the data position information-adding unit 107 generates predetermined data position information, decodes the predetermined data position information into an error-detecting-code, and adds the error-detecting-code to information stored on the header-storing unit 106. Thereby, a header of a frame has been generated. Herein, step 4 can be omitted.

At step 5, the data-generating unit 108, generates data and stores the data into the data-storing unit 109. At step 6, the frame-composing unit 110 composes the header stored in the header-storing unit 106 and the data stored in the data-storing unit 109 to generate a frame. At step 7, the transmitting unit 111 transmits the generated frame to the receiver 200 via the transmission line 300.

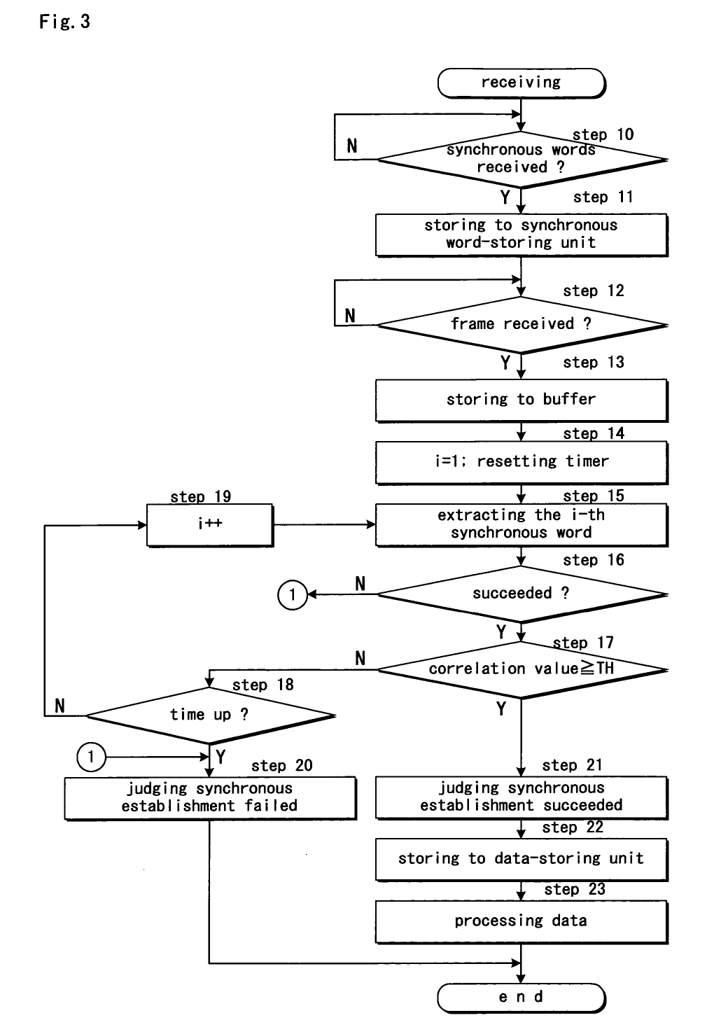

Next, referring to FIG. 3, an outline of operation of the receiver 200 will now be explained. At step 10, the receiving unit 201 waits until the receiving unit 201 receives one or more synchronous words from the transmitter 100. When received, at step 11, the one or more synchronous words are stored into the synchronous word-storing unit 204 via the analyzing unit 203.

At step 12, the receiving unit 201 waits until the receiving unit 201 receives a frame from the transmitter 100. When received, at step 13, the receiving unit 201 clears the buffer 202 and stores the frame into the buffer 202.

At step 14, the analyzing unit 203 sets a value of “1” to a counter “i”, whose value indicates the number of a current synchronous word, and resets the timer 205.

At step 15, the analyzing unit 203 tries to extract the i-th synchronous word from data stored in the buffer 202. When it fails, the analyzing unit 203 moves processes to step 20 and judges that synchronous establishment of the frame has failed, and the process ends.

When it succeeds, at step 17, the analyzing unit 203 outputs the extracted one or more synchronous words and the value of the counter “i” to the correlation-calculating unit 206 to instruct the correlation-calculating unit 206 to perform correlation calculation.

Then, the correlation-calculating unit 206 performs correlation-calculation of the i-th synchronous word stored in the synchronous word-storing unit 204 and the synchronous word inputted from the analyzing unit 203, and outputs a correlation value thereof to the analyzing unit 203.

At step 17, the analyzing unit 203 carries out size comparison of the correlation value inputted from the correlation-calculating unit 206 and a fixed threshold “TH”, when the correlation value inputted from the correlation-calculating unit 206 is greater than the threshold “TH”, the analyzing unit 203 moves processes to step 21.

Otherwise, the analyzing unit 203 moves processes to step 18. At step 18, the analyzing unit 203 checks a measurement value of the timer 205. When the time is up, the analyzing unit 203 moves processes to step 20 and judges that synchronous establishment of the frame has failed. When the time is not up, at step 19, the analyzing unit 203 increases a value of the counter “i” by one and performs processes of step 15 to step 17 regarding the next synchronous word.

At step 21, the analyzing unit 203 judges that synchronous establishment of the frame has succeeded, extracts data from the frame of the buffer 202, and saves the extracted data to the data-storing unit 207. After that, the data-processing unit 208 performs predetermined processes regarding the data of the data-storing unit 207.

Hereinafter, methods for generating one or more synchronous words will now be explained concretely.

(Embodiment 1)

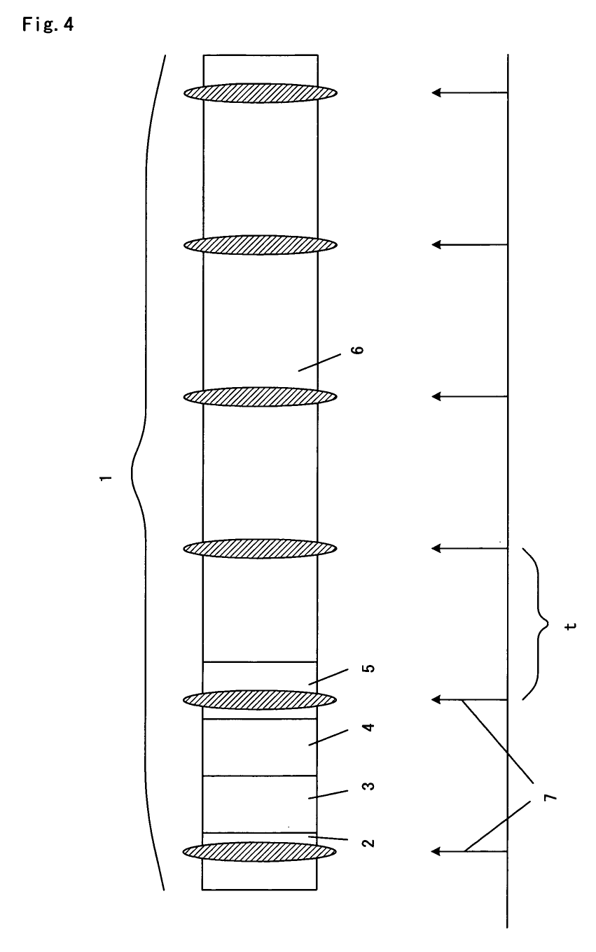

FIG. 4 shows composition of a frame in the embodiment 1 of the present invention. As shown in FIG. 4, a frame 1 comprises synchronous words 2 to 5 and data 6.

In the example of FIG. 4, cyclical noises 7 occur every noise cycle “t”, and portions being given slash lines of the frame 1 are influenced by the cyclical noises 7.

The synchronous word-generating unit 105 determines parameters of the synchronous words 2 to 5, according to the noise cycle “t”. To be more specific, in this example, the synchronous words 2 to 5 have the same pattern altogether, and the synchronous words 2 to 5 are arranged such that three synchronous words 2 to 5 are settled among one section, which is the noise cycle “t” of the cyclical noises 7. It is assumed that the noise cycle “t” has been known.

The synchronous word-generating unit 105 may include one or more other components in the frame. For example, it is considerable that the data position information-adding unit 107 inserts one or more elements showing a data position or data length, either between a certain synchronous word and a synchronous word adjacent to the certain synchronous word or between a certain synchronous word and data adjacent to the certain synchronous word.

A synchronizing method using the frame structure constituted as mentioned above, will now be explained below. First, a frame 1 that the transmitter 100 has constructed as mentioned above reaches the receiver 200 via the transmission line 300. In that event, the frame 1 is influenced by the cyclical noises 7 in the transmission line 300, and a bit error arises in one or more parts of the frame 1. In this example, the bit error has arisen in each of synchronous words 2 and 5 and parts of data 6. The receiver 200 has held, in the synchronous word-storing unit 204, the same one or more synchronous words as those of the transmitter 100.

The correlation-calculating unit 206 calculates correlation between the one or more synchronous words stored in the synchronous word-storing unit 204 and the one or more synchronous words of the received frame 1. In a result of the correlation-calculation, the correlation values of the synchronous words 2 and 5 become low, since the noises 7 affect the frame, and the bit errors arise therein.

However, a high correlation value is obtained regarding synchronous words 3 and 4, which have not been influenced of the noises 7.

The analyzing unit 203 can determine a position of the data 6 based on the synchronous words 3 and 4, whose correlation values are high.

When the noise cycle-measuring unit 103 measures a time interval whose level of the noises 7 is beyond a specific threshold, which is stored in the threshold-storing unit 104, parameters of the one or more synchronous words are determined using the measured time interval as the noise cycle “t” and the same effects as described above are obtained.

(Embodiment 2)

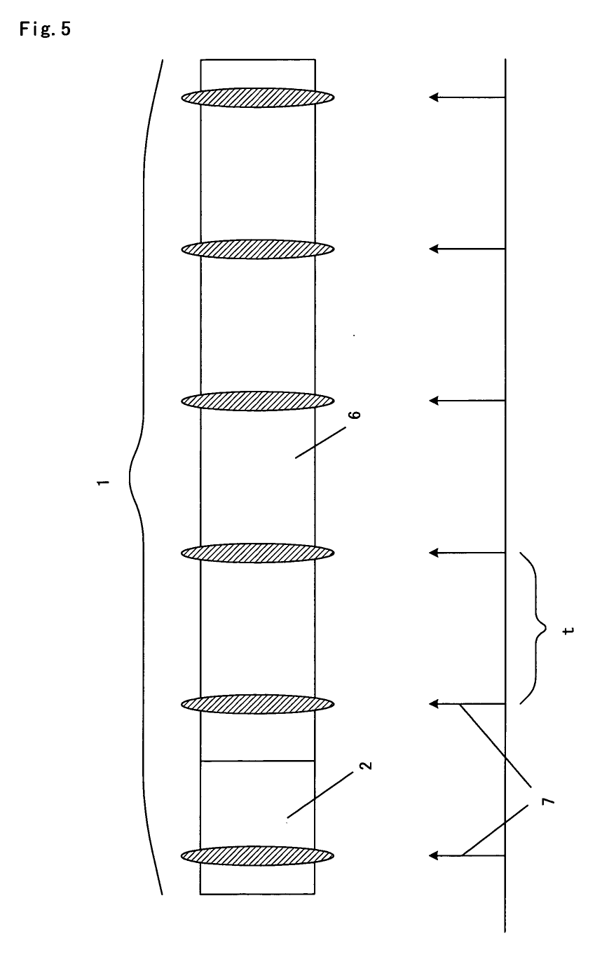

FIG. 5 shows composition of a frame in the embodiment 2 of the present invention. Regarding the same elements as FIG. 4, duplicate explanation is omitted attaching the same symbols.

The frame 1 has only one section, that is, the synchronous word 2, and length of the synchronous word 2 is almost equal to length of a multiple of the cycle “t” by a natural number “n”, where the natural number “n” is greater than zero. In this embodiment, the length of the synchronous word 2 is almost equal to that of the noise cycle “t”, that is, the value of the natural number “n” is one.

A synchronizing method using the frame structure constituted as mentioned above, will now be explained below. First, the transmitter 100 generates a frame 1 as shown in FIG. 5 and transmits the frame 1 to the receiver 200 via the transmission line 300.

In that event, the frame 1 is influenced by the cyclical noises 7 in the transmission line 300, and a bit error arises in one or more parts of the frame 1. In this example, a bit error has arisen in each of synchronous word 2 and parts of data 6.

Since the length of the synchronous word 2 is almost equal to the length of a multiple of the cycle “t” by a natural number “n”, the number of the noises 7 that affect one section of the synchronous word 2 is, at most, the natural number, which is one in this embodiment. Therefore, in the synchronous word 2, rate of sections that are not influenced by the noises 7 increases.

When the correlation-calculating unit 206 calculates the correlation between the one or more synchronous words stored in the synchronous word-storing unit 204 and the one or more synchronous words of the received frame 1, regarding the synchronous word 2, a characteristic that an autocorrelation is high, is obtained.

The analyzing unit 203 can determine a position of the data 6 based on the synchronous word 2 whose correlation value is high.

Similar to the embodiment 1, when the noise cycle-measuring unit 103 measures a time interval whose level of the noises 7 is beyond a specific threshold, which is stored in the threshold-storing unit 104, parameters of the one or more synchronous words are determined using the measured time interval as the noise cycle “t” and the same effects as described above are obtained.

(Embodiment 3)

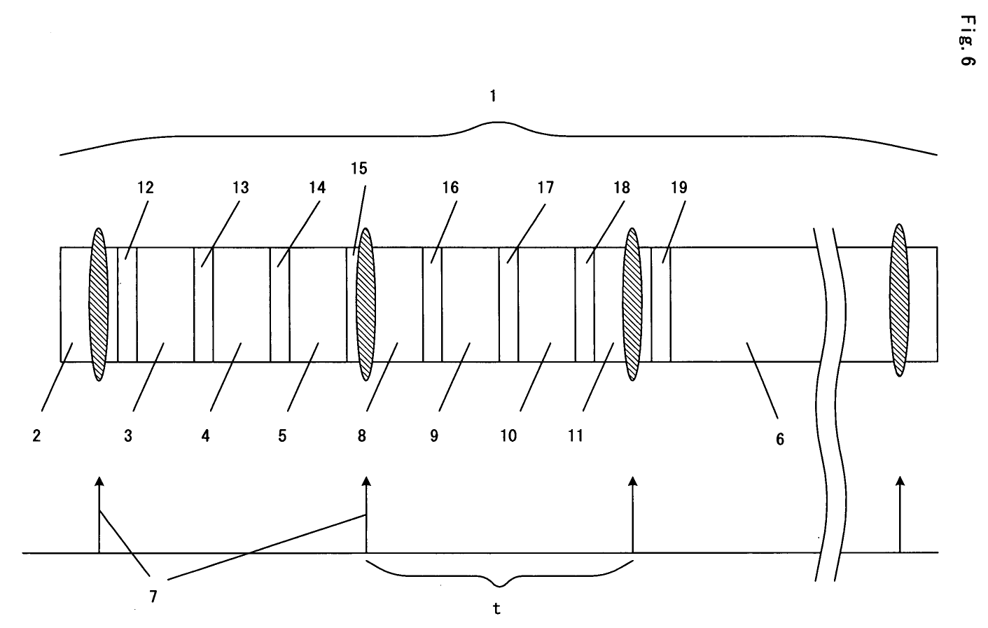

FIG. 6 shows composition of a frame in the embodiment 3 of the present invention. Regarding the same elements as FIG. 4 or FIG. 5, duplicate explanation is omitted attaching the same symbols.

As shown in FIG. 6, in this embodiment, two or more synchronous words 2 to 5, and 8 to 11 are arranged over two or more noise cycle sections in a frame 1. An interval of at least one pair of synchronous words thereof differs from the noise cycle “t”. More specifically, a total of eight sections, which are synchronous words 2 to 5 and 8 to 11, are arranged over two or more noise cycles. For example, an interval of the synchronous word 2 and 9 differs from the noise cycle “t”. Each of the synchronous words need not have a same pattern.

In this embodiment, a total of two kinds of synchronous word patterns are used. Here, the synchronous words 2 to 5 have one kind of synchronous word pattern, and the synchronous words 8 to 11 have the other kind of synchronous word pattern.

In positions behind each of the synchronous words 2 to 5 and 8 to 11, a plurality of sets of data position information 12-19 is arranged. Each of the plurality of sets of data position information 12-19 indicates each of positions of the data 6 seen from each of the synchronous words 2 to 5 and 8 to 11, respectively.

The data position information-adding unit 107 of the transmitter 100 has decoded the data position information 12 to 19 into an error-detecting-code, and the data position information-adding unit 107 has added the error-detecting-code to data of the header-storing unit 106. The analyzing unit 203 of the receiver 200 can obtain precise data position information, performing error detection based on the data position information 12 to 19.

A synchronizing method using the frame structure constituted as mentioned above, will now be explained below. First, a frame 1 that the transmitter 100 has constructed as shown in FIG. 6 reaches the receiver 200 via the transmission line 300.

In that event, the frame 1 is influenced by the cyclical noises 7 in the transmission line 300, and a bit error arises in one or more parts of the frame 1. In this embodiment, the bit error has arisen in each of synchronous words 2, 8 and 11, data position information 15, and parts of data 6.

Since two or more synchronous words 2 to 5 and 8 to 11 exist, one or more synchronous word without the bit error affected by the noises 7 exists. Therefore, when the correlation-calculating unit 206 calculates the correlation between the one or more synchronous words stored in the synchronous word-storing unit 204 and the one or more synchronous word without the bit error affected by the cyclical noises 7, a high correlation value is obtained.

Furthermore, since the synchronous words 2 to 5, and 8 to 11 are arranged covering over the length of two or more noise cycles, when, first, a synchronous word has been detected, secondly, another synchronous word thereafter is detected, the position of data of the frame 1 can be determined more reliably.

Beforehand, the length of synchronous word, the length of data position information, and so on, is known. Therefore, when one synchronous word can be detected, a position of the previous data position information thereof and a position of the following data position information thereof can also be determined.

Using these relationships, when a data position is determined, since not only data position information corresponding to a detected synchronous word but also previous/following data position information thereof can be utilized, a position of data of the frame 1 can be determined more reliably.

To be more specific, when the synchronous word 5 has been detected, it is desirable that a position of data is determined using not only the data position information 15 corresponding to the synchronous word 5 but also previous data position information 14.

In this embodiment, an error has arisen in the data position information 15. However, there is no possibility that an error arises in both the data position information 14 and the data position information 15 being affected by the cyclical noises 7.

The data position information-adding unit 107 has decoded each of data position information 12 to 19 into an error detecting code. Therefore, when at least one of the data position information 14 and 15 and the data position information 14, which the receiver 200 has not detected any error, is used, the data position can be determined correctly. Furthermore, even when the error has arisen in the data position information 15, the data position can be determined correctly.

In this embodiment, two kinds of synchronous word patterns are used. However, three or more kinds of synchronous word patterns may be used retaining the same effects as described above. Furthermore, in this embodiment, the data position information 15 and the previous data position information 14 thereof is used. However, the data position information 15 and two or more sets of data position information except the data position information 15 itself may be used retaining the same effects as described above.

Similar to the embodiment 1, when the noise cycle-measuring unit 103 measures a time interval whose level of the noises 7 is beyond a specific threshold, which is stored in the threshold-storing unit 104, parameters of the one or more synchronous words are determined using the measured time interval as the noise cycle “t” and the same effects as described above are obtained.

According to the present invention, in the transmission line where cyclical noises exist, parameters of one or more synchronous words are determined considering noise cycle, thereby, reducing effects of the cyclical noises, reliability of frame synchronization establishment can be improved.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A frame synchronization method comprising:
composing data and a synchronous word to generate a frame;
transmitting the generated frame from a transmitter to a receiver via a transmission line,
wherein said composing the data and the synchronous word arranges the synchronous word based on noise cycle of the transmission line.

2. A frame synchronization method as recited in claim 1, wherein the synchronous word is arranged according to predetermined arrangement algorithm.

3. A frame synchronization method as recited in claim 2, wherein a parameter of the predetermined arrangement algorithm comprises at least one of length of the synchronous word and an arrangement interval of the synchronous word.

4. A frame synchronization method as recited in claim 1, wherein the length of the synchronous word is almost equal to the length of a multiple of the noise cycle by a natural number.

5. A frame synchronization method comprising:
composing data and a plurality of synchronous words to generate a frame;
transmitting the generated frame from a transmitter to a receiver via a transmission line,
wherein said composing the data and the plurality of synchronous words arranges the plurality of synchronous words based on noise cycle of the transmission line.

6. A frame synchronization method as recited in claim 5, wherein said composing the data and the synchronous words arranges the plurality of synchronous words over a section as long as the noise cycle.

7. A frame synchronization method as recited in claim 5, wherein the length of an arrangement interval of at least one pair of the plurality of synchronous words is different from the length of the noise cycle.

8. A frame synchronization method as recited in claim 5, wherein at least one pair of the plurality of synchronous words are arranged using the same pattern.

9. A frame synchronization method as recited in claim 1, wherein the length of the noise cycle is the length of a time interval whose noise level in the transmission line is beyond a predetermined threshold.
